(19) United States
(12) Patent Application Publication
(10) Pub. No.: US 2017/0060567 A1
(43) Pub. Date: Mar. 2, 2017

(54) WIRELESS TERMINAL COMMUNICABLE WITH EXTERNAL DEVICE AND SERVER AND SOFTWARE UPDATING METHOD THEREOF

(71) Applicant: Samsung Electronics Co., Ltd., Suwon-si (KR)

(72) Inventors: Sang Jae KIM, Suwon-si (KR); Soon Yeon CHOI, Seoul (KR)

(21) Appl. No.: 15/247,110

(22) Filed: Aug. 25, 2016

(30) Foreign Application Priority Data
Aug. 27, 2015 (KR) 10-2015-0121009

(51) Int. Cl. G06F 9/445; H04L 12/24; H04W 4/00

(52) U.S. Cl. CPC G06F 8/65; H04W 4/001; H04L 41/0859

(57) ABSTRACT

A wireless terminal and a method for updating software installed on the wireless terminal are provided. The wireless terminal is communicable with an external device, a first server, and a second server. The method includes receiving update policy information on the software from the first server, obtaining a latest version of the software newer than a version of the software from the second server, and, if state information of the external device satisfies an installation condition for the obtained latest version of the software according to the received update policy information, installing the obtained latest version of the software on the wireless terminal.

### CROSS-REFERENCE TO RELATED APPLICATION(S)

This application claims the benefit under 35 U.S.C. §119(a) of a Korean patent application filed on Aug. 27, 2015 in the Korean Intellectual Property Office and assigned Serial number 10-2015-0121009, the entire disclosure of which is hereby incorporated by reference.

### TECHNICAL FIELD

The present disclosure relates to a method of updating a firmware installed at a wireless terminal communicable with an external device and a server, and a wireless terminal for performing the same.

### BACKGROUND

Recently, with the rapid development of information communication technology and semiconductor technology, the supply and use of terminals have increased greatly. Recent terminals have reached a mobile convergence phase that covers the areas of other terminals without staying in each traditional original area.

In the case of such terminals, they operate via firmware. The firmware refers to one type of program that stores key software having data or information not required to be changed in read only memory (ROM) and is used as if it was hardware. To provide a stable performance of a product and modify bug, a new version of firmware may be continued to develop after the release of the product.

If a new version of firmware is developed, a terminal may update pre-installed firmware. A terminal may update firmware through various methods using wired or wireless network. In the case of a terminal available for wireless communication with a server, firmware update is possible using wireless communication. A representative example of a firmware updating method using wireless communication includes firmware over the air (FOTA) service.

The FOTA service refers to a service for updating the firmware of a wireless terminal as a server provides a delta file corresponding to a new version of firmware to the wireless terminal via wireless network. That is, the wireless terminal may obtain the delta file, and update an old version of previously installed firmware to the latest version of firmware by using the obtained delta file.

A wireless terminal where software update is possible using a wireless communication method may continuously communicate with an external device and perform a function for checking or controlling a state of the external device.

Especially, a wireless terminal may collect a state of an external device at a critical moment such as when a vehicle receives an impact, and store the collected information in the wireless terminal or transmit it to a server. If software (for example, firmware) of the wireless terminal is updated at this point, the wireless terminal may not collect state information of an external device or may not store/transmit collected information at the above-mentioned critical moment due to rebooting that occurs during a firmware update process. Accordingly, the software of the wireless terminal is required to be updated when the external device is in a stable state (for example, a vehicle operation is stopped).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for updating a firmware of a wireless terminal in consideration of an external device communicating with the wireless terminal and the wireless terminal.

In accordance with an aspect of the present disclosure, a method for updating software installed on a wireless terminal communicable with an external device, a first server, and a second server is provided. The method includes receiving, at the wireless terminal, update policy information on the software from the first server, obtaining, at the wireless terminal, a latest version of software from the second server, and if state information of the external device satisfies an installation condition for the obtained latest version of software according to the received update policy information, installing the obtained latest version of software on the wireless terminal.

In an embodiment of the present disclosure, the update policy information is information relating to an update policy registered by a user of the wireless terminal or an administrator who accesses the first server.

In an embodiment of the present disclosure, the update policy information comprises at least one of an update available time of the latest version of software, state information of an update available or an unavailable external device of the latest version software, and an update attempt period of the latest version of software.

In an embodiment of the present disclosure, the state information of the external device comprises at least one of an amount of battery charge remaining in the external device, a temperature of the external device, a moving speed of the external device, information on an operating state of the external device, a sensor value of a gyroscope of the external device, and an acceleration of the external device.

In an embodiment of the present disclosure, the installing of the obtained latest version of software on the wireless terminal comprises receiving an update execution request from the first server and installing the obtained latest version of software on the wireless terminal in response to the update execution request.

In an embodiment of the present disclosure, the method may further comprise transmitting notification information on an update state of the software to at least one of the first server, the second server, and a portable terminal of a user of the wireless terminal.

In an embodiment of the present disclosure, a latest version of software is a whole or a part of software update data or difference data between an old version of pre-installed software and a latest version of the software.

In an embodiment of the present disclosure, the first server and the second server may be implemented as a same server.

In an embodiment of the present disclosure, the method may further comprise obtaining state information of the wireless terminal, wherein the installing of a latest version of the software on the wireless terminal comprises, if the obtained state information of the wireless terminal satisfies an installation condition of the obtained software according to the update policy information, installing the obtained latest version of the software on the wireless terminal.

In an embodiment of the present disclosure, the state information of the wireless terminal comprises at least one of an amount of battery charge remaining in the wireless terminal, a location of the wireless terminal, a temperature of the wireless terminal, and a communication state of the wireless terminal.

In an embodiment of the present disclosure, the obtaining of a latest version of the software comprises, according to the received update policy information on the software, obtaining the latest version of software from the second server.

In an embodiment of the present disclosure, the method may further comprise, according to the received update policy information, determining whether the state information of the external device satisfies an installation condition of the obtained latest version of software.

In accordance with another aspect of the present disclosure, a method for updating software installed on a wireless terminal device communicable with an external device, a portable terminal, and a server may comprises receiving, at the wireless terminal, update policy information on the software from the portable device, obtaining, at the wireless terminal, a latest version of the software from the server, and if state information of the external device satisfies an installation condition for the obtained latest version of the software according to the received update policy information, installing the obtained latest version of the software on the wireless terminal.

In accordance with another aspect of the present disclosure, a wireless terminal communicable with an external device, a first server, and a second server is provided. The wireless terminal includes a communication circuit configured for receiving update policy information on an update of software installed on the wireless terminal from the first server, and obtaining a latest version of the software newer than a version of the software from the second server, and a processor configured to control for, if the state information of the external device satisfies an installation condition of the obtained latest version of the software according to the received update policy information, installing the obtained latest version of the software on the wireless terminal.

In an embodiment of the present disclosure, when the communication circuit receives update execution request information, the processor is further configured to control for installing the obtained latest version of the software on the wireless terminal.

In an embodiment of the present disclosure, the communication circuit transmits notification information on an update state of the software to at least one of the first server, the second server, and a portable terminal of a user of the wireless terminal.

In an embodiment of the present disclosure, the wireless terminal further comprises a detection unit configured for obtaining state information of the external device, wherein when the state information of the external device obtained by the detection unit satisfies an installation condition of the obtained software according to the update policy information, the processor is further configured to control for installing the obtained latest version of the software on the wireless terminal.

In an embodiment of the present disclosure, the communication circuit obtains state information of the external device from the external device, wherein when the state information of the external device obtained by the communication circuit satisfies an installation condition of the obtained software according to the update policy information, the processor is further configured to control for installing the obtained latest version of the software on the wireless terminal.

In an embodiment of the present disclosure, the communication circuit comprises a first communication circuit configured for receiving update policy information necessary for updating the software from the first server and obtaining a latest version of the software from the second server in a wireless communication method and a second communication circuit configured for obtaining state information of the external device from the external device in a wired communication method.

In an embodiment of the present disclosure, the communication circuit obtains the latest version of the software newer than a version of the software from the second server according to the received update policy information on the software.

In an embodiment of the present disclosure, if the state information of the external device satisfies an installation condition of the obtained latest version of software according to the received update policy information, the processor is configured to control for installing the obtained latest version of the software on the wireless terminal.

In accordance with another aspect of the present disclosure, a wireless terminal communicable with an external device, a portable terminal, and a server is provided. The wireless terminal includes a communication circuit configured for receiving update policy information necessary for updating software installed on the wireless terminal from the portable terminal, and obtaining a latest version of the software newer than a version of the software from the server, and a processor configured to control for, if the state information of the external device satisfies an installation condition of the obtained latest version of the software according to the received update policy information, installing the obtained latest version of the software on the wireless terminal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view illustrating a system where a software update of a wireless terminal is performed according to an embodiment of the present disclosure;

FIG. 2A is a schematic block diagram illustrating a configuration of a wireless terminal according to an embodiment of the present disclosure;

FIG. 2B is a schematic block diagram illustrating a configuration of a wireless terminal according to an embodiment of the present disclosure;

FIG. 3A is a flowchart illustrating a software updating method of a wireless terminal according to an embodiment of the present disclosure;

FIG. 3B is a flowchart illustrating a software updating method of a wireless terminal according to an embodiment of the present disclosure;

FIG. 3C is a flowchart illustrating a software updating method of a wireless terminal according to an embodiment of the present disclosure;

FIG. 4 is a view illustrating syntaxes for representing update policy information according to an embodiment of the present disclosure;

FIG. 5 is a view illustrating syntaxes for representing update policy information according to an embodiment of the present disclosure;

FIG. 6 is a view illustrating a screen for registering an update policy according to an embodiment of the present disclosure;

FIG. 7 is a flowchart illustrating a software updating method of a wireless terminal according to an embodiment of the present disclosure; and

FIG. 8 is a flowchart illustrating a software updating method of a wireless terminal according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different users regardless of order or importance. For example, a first component may be referred to as a second component and vice versa without departing from the scope and spirit of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding embodiments of the present disclosure.

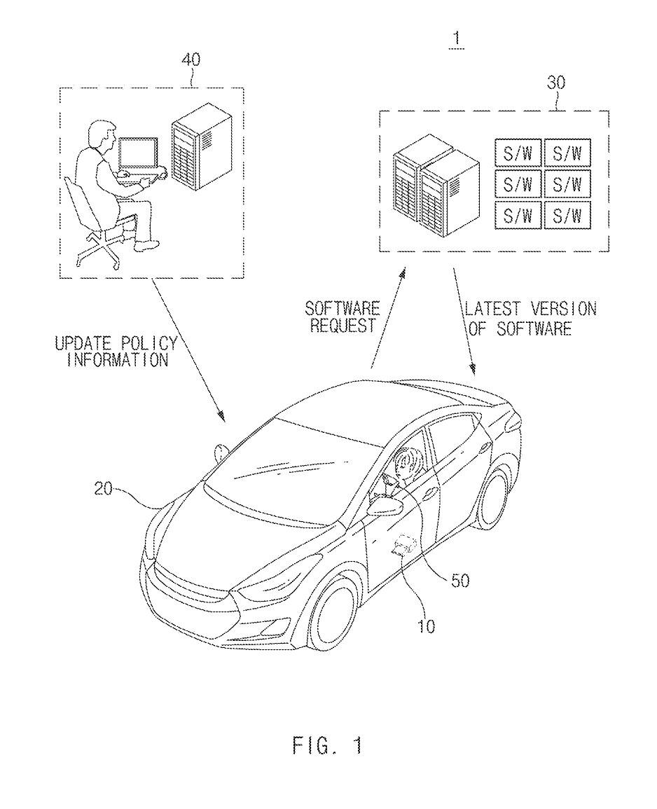

FIG. 1 is a schematic view illustrating a system where a software update of a wireless terminal is performed according to an embodiment of the present disclosure.

Referring to FIG. 1, a system 1 may include a wireless terminal 10, an external device 20, a software server 30, a management server 40, and a portable terminal 50.

Referring to FIG. 1, the wireless terminal 10 may collect state information of the external device 20, or control a function of the external device 20 while performing communication in connection to the external device 20. The wireless terminal 10, for example, may include at least one of on board diagnostics (OBD), a smartphone, a tablet personal computer (PC), a mobile phone, a video telephone, an electronic book reader, a desktop PC, a laptop PC, a netbook computer, a personal digital assistant (PDA), a portable multimedia player (PMP), a motion picture experts group (MPEG-1 or MPEG-2) audio layer 3 (MP3) player, a mobile medical device, a camera, or a wearable device.

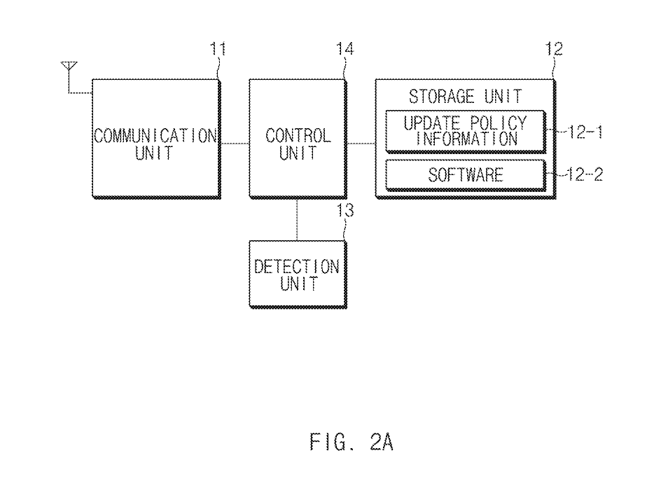

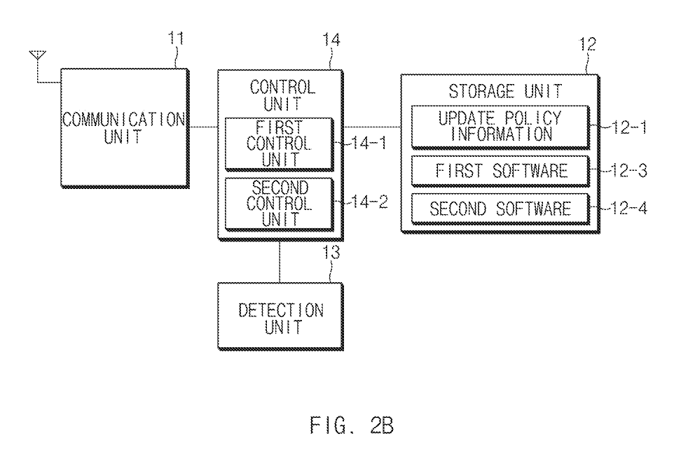

According to various embodiments of this disclosure, as one example of the wireless terminal 10, an OBD is mainly described as a target. The OBD may check information on an engine state such as an engine revolution per minute (RPM), a coolant temperature, an intake air temperature, an intake air amount, an engine oil temperature, a transmission oil temperature, a fuel injection amount, an oxygen sensor voltage, an ignition angle, a carbon emission amount, or an air-fuel ratio learning amount and information on a vehicle state such as a brake state, a battery voltage, or an air conditioning refrigerant pressure, in addition to information on a driving state such as the speed, driving time, RPM, driving distance, average fuel consumption, or instantaneous fuel consumption of the external device 20 (for example, a vehicle). If a problem in a vehicle occurs, information on the problem in the vehicle may be checked through data collected through the OBD. Such a configuration of the wireless terminal 10 will be described in more detail with reference to FIGS. 2A and 2B.

Referring to FIG. 1, the external device 20, for example, may include at least one of a transportation means (for example, a vehicle, an airplane, a motorcycle, a train or a ship), a smartphone, a tablet PC, a mobile phone, a video telephone, an electronic book reader, a desktop PC, a laptop PC, a netbook computer, a PDA, a PMP, an MP3 player, a mobile medical device, a camera, or a wearable device. In some various embodiments of the present disclosure, the external device 20 may be a home appliance. The home appliance may include at least one of, for example, a television (TV), a digital versatile disc (DVD) player, an audio, a refrigerator, an air conditioner, a cleaner, a washing machine, an air cleaner, a set-top box, a home automation control panel, a security control panel, a television (TV) box, and a game console (e.g., Xbox™ or PlayStation™). In other various embodiments of the present disclosure, the external device 20 may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

With reference to FIG. 1, as one example of the external device 20, a vehicle in a transportation means is mainly described as a target. The vehicle 20, as shown in the drawing, may be configured in a form of loading and transporting people and cargo. Especially, the vehicle 20 may include a vehicle electronic control system (not shown) in order to electrically control various functions relating to driving. The vehicle electronic control system may be a system for supporting an overall driving function control of the vehicle 20 with the mounted wireless terminal 10, for example, electronically supporting various controls such as an emission gas control, an engine control a light control, a brush control, and so on. The vehicle electronic control system may include a vehicle connector (for example, an OBD terminal or an OBD connector) for connection with the wireless terminal 10. The vehicle connector may be prepared in at least one form among various forms to be adapted to a connector structure of various wireless terminals 10.

Referring to FIG. 1, the software server 30 may correspond to a server for providing a software upgrade service of the wireless terminal 10. For example, the software server 30, as a server for providing a firmware over the air (FOTA) service for a firmware update of the wireless terminal 10, for example, may be a manufacturer server of the wireless terminal 10 or a management server of the wireless terminal 10. When a new version of software (for example, firmware) is developed, the software server 30 may transmit the latest version of the software to the wireless terminal 10. According to an embodiment of the present disclosure, the latest version of the software, for example, may be a whole or a part of software update data to be provided for the update, or may be difference data between an old version of the software installed on the wireless terminal 10 and the latest version of the software. The difference data of the software, for example, may be a delta file (for example, delta binary data).

Referring to FIG. 1, the management server 40 may be a server where a user or an administrator of the wireless terminal 10 registers an update policy.

A user or an administrator may access the management server 40 to register an update policy. The update policy may include various types of policies for an update condition of the software. For example, update policy information may include policy information for obtaining the latest version of the software from the management server 40 and policy information for installing the obtained latest version of the software to the wireless terminal 10.

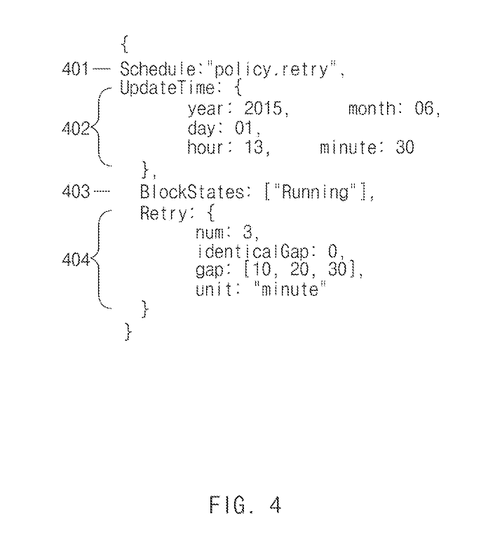

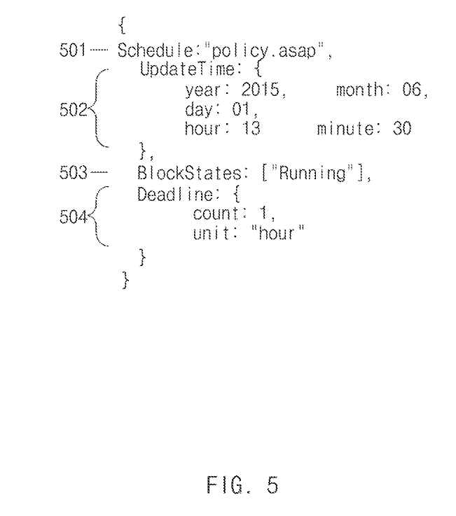

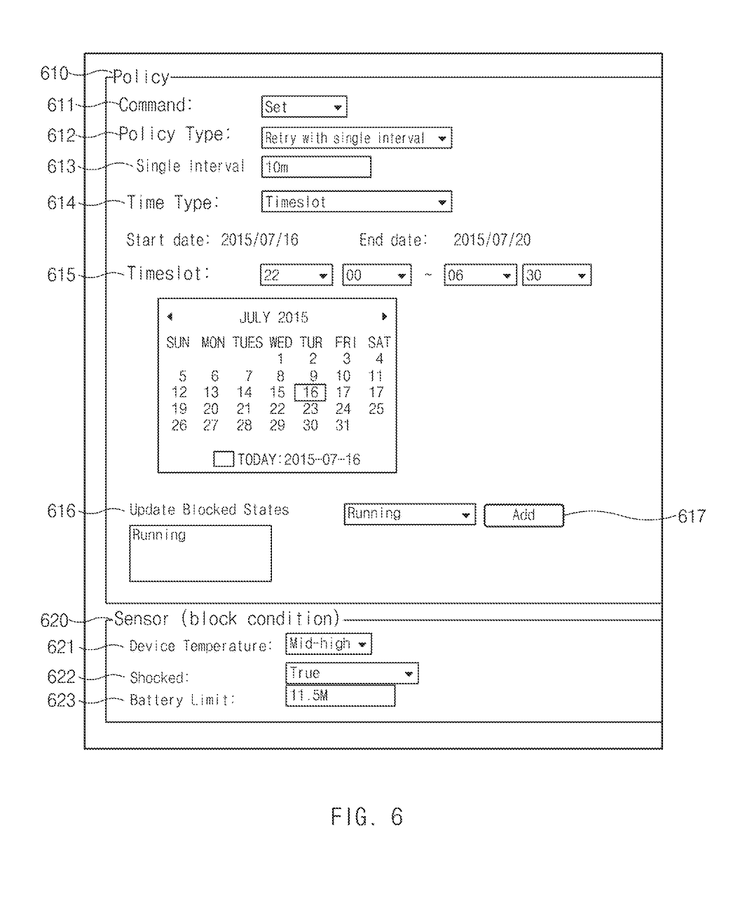

One example of a user interface screen for registering an update policy by an administrator will be described in more detail with reference to FIG. 6. When an update policy is registered, the management server 40 may transmit update policy information that is update policy related information to the wireless terminal 10. The update policy information may be divided into a plurality of data packets or a plurality of file packages and transmitted with a time difference. For example, policy information for obtaining the latest version of the software and policy information for installing the latest version of the software to the wireless terminal 100 may be transmitted at different times. According to an embodiment of the present disclosure, receiving, by the wireless terminal 10, update policy information includes receiving, by the wireless terminal 10, a part and another part of the update policy information with a time difference. One example of the update policy information will be described in more detail with reference to FIGS. 4 and 5.

The management server 40 and the software server 30 may be configured as one server. Additionally, at least one function described to be performed by the management server 40 or the software server 30 may be performed by another server. Hereinafter, for convenience of description, the software server 30 and the management server 40 are described separately.

Referring to FIG. 1, the portable terminal 50 may be gripped or carried by a user, or may be provided or disposed at a predetermined position of the vehicle 20. The portable terminal 50 may support various user functions according to a user manipulation. For example, the portable terminal 50 may support various functions such as a navigation function, a black box function, a music playback function, a call function, and a search function according to the type of an installed application program and a user manipulation. According to an embodiment of the present disclosure, the portable terminal 50 may include an input unit (for example, a speaker, a display unit, or a haptic unit) for providing notification information on an update state. The portable terminal 50, for example, may include at least one of a smartphone, a tablet PC, a mobile phone, a video telephone, an electronic book reader, a desktop PC, a laptop PC, a netbook computer, a PDA, a PMP, an MP3 player, a mobile medical device, a camera, or a wearable device. In this disclosure, as one example of the portable terminal 50, a smartphone including all of a speaker, a display unit, and a haptic unit is mainly described as a target.

The portable terminal 50 may receive notification information on an update state from at least one of the wireless terminal 10, the software server 30, and the management server 40. The portable terminal 50 may indirectly receive notification information on an update state through a relay such as an access point (AP) or a base station (not shown).

The notification information on the update state may include various types of notification information such as update success, update failure, update progress, update execution, or update check. The notification information on the update state may be provided through an output unit of the portable terminal 50 or the wireless terminal 10. If the portable terminal 50 is in a plurality, the notification information on the update state may be provided through the output unit of the portable terminal 50 that is registered as a target for outputting update notification information in advance. Alternatively, the notification information on the update state may be provided through an output unit of the portable terminal 50 having a history of communicating with the wireless terminal 10.

A user of the wireless terminal 10 may access the management server 40 through the portable terminal 50. If a user interface provided by the management server 40 is provided through the display unit of the portable terminal 50, the user may register an update policy through a user interface.

Referring to FIG. 1, a user or an administrator of the wireless terminal 10 may access the management server 40 to register the update policy of software installed on the wireless terminal 10. When an update policy is registered, the management server 40 may generate update policy information based on the registered update policy, and transmit the generated update policy information to the wireless terminal 10. The wireless terminal 10 may request software from the software server 30 according to the received update policy information. In correspondence to the request, the wireless terminal 10 may obtain a latest version of the software in comparison to the software installed on the wireless terminal 10, from the software server 30.

The wireless terminal 10 may obtain state information of the external device 20 or state information of the wireless terminal 10. The wireless terminal 10 may obtain state information of the external device 20 or the wireless terminal 10 by using a sensor of the wireless terminal 10, or receive state information of the external device 20 from the external device 20. The state information of the external device 20, for example, may include an amount of battery charge remaining in the external device 20, a temperature of the external device 20, a moving speed of the external device 20, whether there is an impact on the external device 20, a gyroscope sensor value of the external device 20, or an acceleration of the external device 20. The state information of the external device 20 may further include information on an operating state of the external device 20. Information on an operating state of the external device 20 may include a variety of information relating to an operation of the external device 20 such as the driving, starting, forward, backward, or stopping of the external device 20.

The state information of the wireless terminal 20, for example, may include an amount of battery charge remaining in the wireless terminal 10, a location of the wireless terminal 10, a temperature of the wireless terminal 10, or a communication state of the wireless terminal 10.

If the obtained state information of the external device 20 or the wireless terminal 10 satisfies a software installation condition, the wireless terminal 10 may install the obtained latest version of the software thereto.

FIG. 2A is a block diagram illustrating a configuration of the wireless terminal 10 conceptually according to an embodiment of the present disclosure.

Referring to FIG. 2A, the wireless terminal 10 may include a communication unit 11, a storage unit 12, a detection unit 13, and a processor or control unit 14. The communication unit 11 may be replaced with a communication circuit; the storage unit 12 may be replaced with a storage; the detection unit 13 may be replaced with a sensing circuit; and the control unit 14 may be replaced with a processor. In addition, the wireless terminal 10 may further include a component such as an audio processing unit including a microphone and a speaker, a touch pad for touch based input, an input unit for supporting a physical key input, a display unit for displaying screen data according to an operation of the wireless terminal 10, a light emitting unit including a light-emitting diode (LED), and a battery for supplying power to the above components.

The communication unit 11 may perform communication with the external servers 30 and 40 and the external device 20 in a wired/wireless communication manner.

When performing communication in a wireless communication manner, the communication unit 11, for example, may perform communication in a Wi-Fi method, a Bluetooth (BT) method, or a near field communication (NFC) method. The communication unit 11 may first transmit/receive various connection information such as stands for service set identifier (SSID) and a session key, and transmit/receive various information after establishing a communication connection by using the connection information (for example, after forming a communication channel). Additionally, the communication unit 11 may perform communication according to various communication standards such as Institute of Electrical and Electronics Engineers (IEEE), Zigbee, 3rd Generation (3G), 3rd Generation Partnership Project (3GPP), and long term evolution (LTE).

When performing communication in a wired communication method, the communication unit 11, for example, may use a 20-pin connector, a 16-pin connector, or a universal serial bus (USB) connector. The communication unit 11 may perform communication through an interface method according to on-board diagnosis version I (OBD-1), OBD-2, European on-board diagnosis (EOBD), or Korean on-board diagnosis (KOBD) standards.

The communication unit 11 may be divided into a plurality of communication modules according to a target for performing communication or a method of performing communication. According to an embodiment of the present disclosure, the communication unit 11 may be divided into a first communication circuit for communicating with the software server 30, a second communication circuit for communicating with the management server 40, and a third communication circuit for communicating with the external device 20. However, according to another embodiment of the present disclosure, the communication unit 11 may be divided into a first communication circuit for performing communication in a wireless communication method and a second communication circuit for performing communication in a wired communication method.

According to an embodiment of the present disclosure, with reference to FIG. 2A, the communication unit 11 may receive update policy information from the management server 40 in a wireless communication method. Then, according to the received update policy information, the communication unit 11 may obtain the latest version of software in comparison to the software installed on the wireless terminal 10, from the software server 30, in a wireless communication method. Then, the communication unit 11 may collect state information of the external device 20 therefrom in a wired communication method. When the latest version of the software is installed on the wireless terminal 10 according to the collection result of the state information, the communication unit 11 may transmit success notification information of a software update to the portable terminal 50 in a wireless communication method. When the software update has failed, the communication unit 11 may transmit failure notification information of the software update to the portable terminal 50 in a wireless communication method.

The storage unit 12 may store various programs and data executed and processed by the wireless terminal 10, and may be configured with at least one of nonvolatile memory and volatile memory. For example, the nonvolatile memory may correspond to read only memory (ROM) and flash memory, and the volatile memory may correspond to random access memory (RAM). Additionally, the storage unit 12 may include a memory card (not shown) (for example, micro secure digital (SD) card and memory stick) mounted in the wireless terminal 10.

According to an embodiment of the present disclosure, the storage unit 12 may include an update policy information storage area 12-1 (shown in FIG. 2A) for storing update policy information received from the management server 40 through the communication unit 11. Additionally, the storage unit 12 may include a software storage area 12-2 (shown in FIG. 2A) for temporarily or permanently storing software (for example, firmware) necessary for controlling a function performed by the wireless terminal 10. A latest version of the software received according to a software update request may be temporarily or permanently stored in the software storage area 12-2.

The detection unit 13 may be configured with various sensors to detect a state of the wireless terminal 10 and a state of the external device 20. For example, the detection unit 13 may include at least one of an acceleration sensor, a gyro sensor, an illuminance sensor, a proximity sensor, a pressure sensor, a noise sensor (for example, a microphone), a video sensor (for example, a camera module), a temperature sensor, a shock sensor, and a timer.

As a state value of the external device 20, the detection unit 13 may detect at least one of an amount of battery charge remaining in the external device 20, a temperature of the external device 20, a moving speed of the external device 20, whether there is an impact on the external device 20, and an acceleration of the external device 20. Additionally, the detection unit 13 may detect at least one of an update deadline, a software installation deadline, an update installation period, and a detection period of the external device 20 by using a timer. Additionally, as state information of the wireless terminal 10, the detection unit 13 may detect at least one of a temperature, a remaining amount of battery charge, and an operating state of the wireless terminal 10.

The processor or control unit 14 controls overall operations of the wireless terminal 10. Especially, the control unit 14 may control an operation relating to a function management for updating software according to various embodiments of the present disclosure.

For example, the control unit 14 may receive update policy information necessary for a software update from the management server 40 through the communication unit 11. According to the received update policy information, the control unit 14 may obtain the latest version of software in comparison to software installed on the wireless terminal 10, from the software server 30, through the communication unit 11.

If the state information of the external device 20 obtained through the detection unit 13 satisfies an installation condition for the latest version of the software, the control unit 14 may install the latest version of the software on the wireless terminal 10.

FIG. 2B is a block diagram illustrating a configuration of the wireless terminal 10 conceptually according to an embodiment of the present disclosure.

Referring to FIG. 2B, the wireless terminal 10 may include a communication unit 11, a storage unit 12, a detection unit 13, and a control unit 14. The control unit 14 may include a first control unit 14-1 and a second control unit 14-2. In addition, the wireless terminal 10 may further include a component such as an audio processing unit including a microphone and a speaker, a touch pad for touch based input, an input unit for supporting a physical key input, a display unit for displaying screen data according to an operation of the wireless terminal 10, a light emitting unit including an LED, and a battery for supplying power to the above components.

The communication unit 11 may perform communication with the external servers 30 and 40 and the external device 20 in a wired/wireless communication manner Detailed examples of the communication unit 11 refer to the communication unit 11 of FIG. 2A described above.

The detection unit 13 may be configured with various sensors to detect a state of the wireless terminal 10 and a state of the external device 20. Detailed examples of the detection unit 13 refer to the detection unit 13 of FIG. 2A described above.

The processor or control unit 14 may control overall operations of the wireless terminal 10. The control unit 14 may include a first control unit 14-1 and a second control unit 14-2. The first control unit 14-1 and the second control unit 14-2 may control an operation of the wireless terminal 10 and may be divided according to their purpose, function or configuration. For example, the first control unit 14-1 may be an operating system (for example, Android® OS or Tizen® OS) or an Application Processor (AP) for driving an application program. The second control unit 14-2 may be a micro controller unit (MCU) (for example, an MCT of OBD-1 or OBD-2) for performing the self-diagnosis of the external device 20.

The storage unit 12 may store various programs and data executed and processed by the wireless terminal 10, and may be configured with at least one of nonvolatile memory and volatile memory. Detailed examples of the storage unit 12 refer to the storage unit 12 of FIG. 2A described above. The storage unit 12 may include an update policy information storage area 12-1 (shown in FIG. 2B) for storing update policy information, a first software storage area 12-3 (shown in FIG. 2B) for storing first software (for example, first firmware) necessary for managing the first control unit 14-1, and a second software storage area 12-4 (shown in FIG. 2B) for storing second software (for example, second firmware) necessary for managing the second control unit 14-2.

Referring to FIG. 2B, the first control unit 14-1 may receive update policy information necessary for updating software from the management server 40 (shown in FIG. 1) or the portable terminal 50 (shown in FIG. 1) through the communication unit 11, and store the update policy information in the update policy information storage area 12-1. Then, according to the received update policy information, the first control unit 14-1 may receive a latest version of the first software and a latest version of the second software through the communication unit 11.

According to an embodiment of the present disclosure, with reference to FIG. 2B, the first control unit 14-1 may update the first software pre-stored in the first software storage area 12-3 by using the received latest version of the first software. Additionally, the control unit 14 may transmit the received latest version of the second software to the second control unit 14-2. According to the update policy information, the second control unit 14-2 may update the second software pre-stored in the second software storage area 12-4 by using the received latest version of the second software. For example, if the state information of the external device 20 satisfies an installation condition according to the update policy information, the second control unit 14-2 may update the second software pre-stored in the second software storage area 12-4 by using the received latest version of the second software.

According to another embodiment of the present disclosure, with reference to FIG. 2B, the first control unit 14-1 or the second control unit 14-2 may update both the first software pre-stored in the first software storage area 12-3 and the second software pre-stored in the second software storage area 12-4 by using the received latest version of the first software and second software. For example, if the state information of the external device 20 satisfies an installation condition according to the update policy information, the first control unit 14-1 or the second control unit 14-2 may update both the first software pre-stored in the first software storage area 12-3 and the second software pre-stored in the second software storage area 12-4 by using the received latest version of the first software and second software.

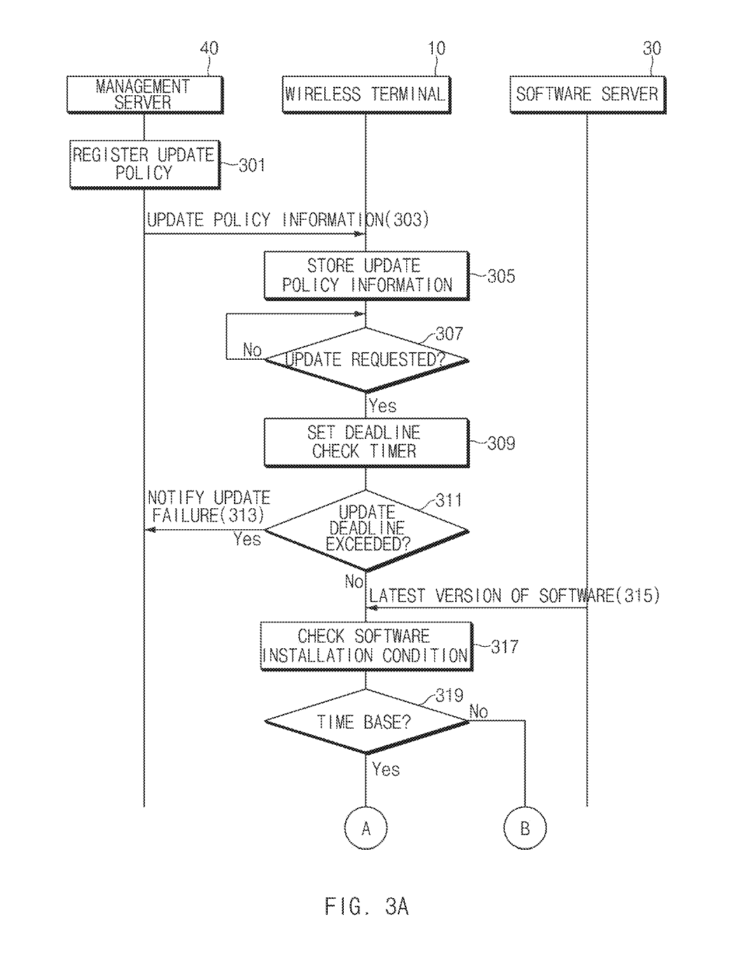

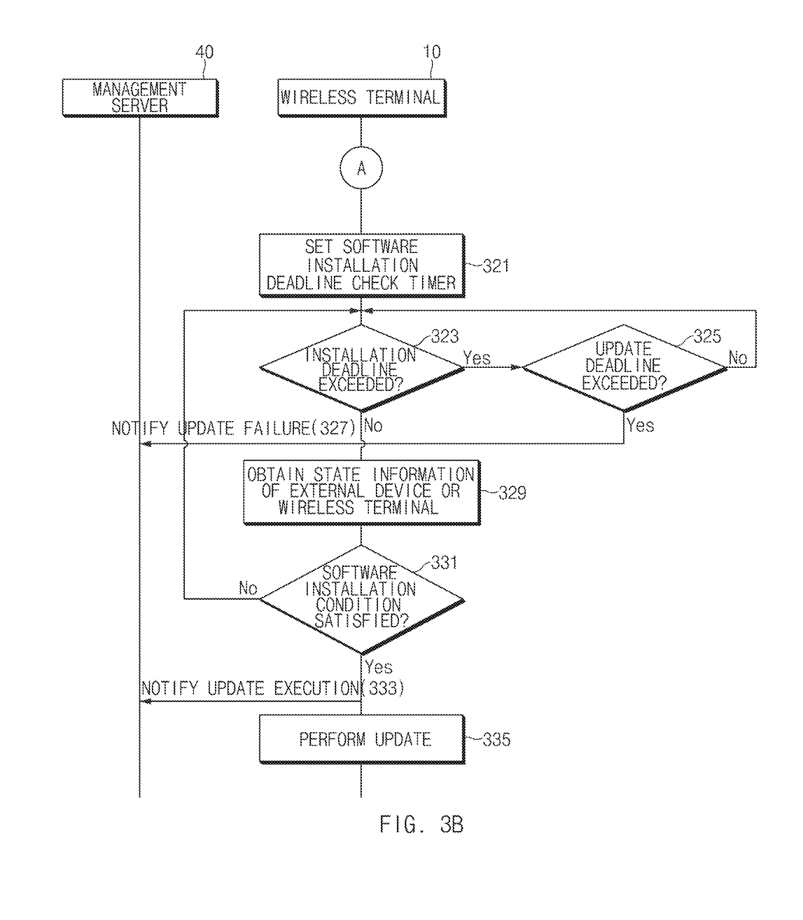

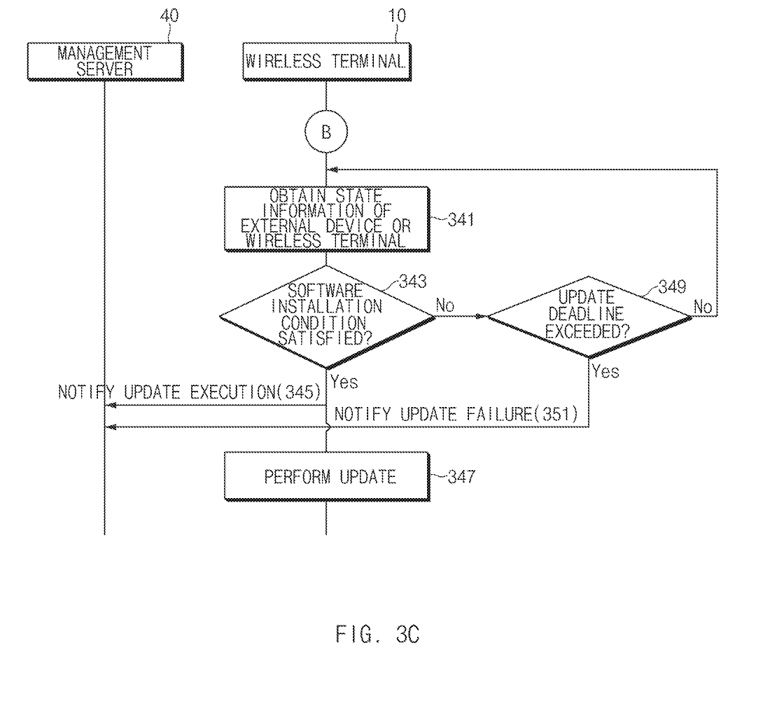

FIGS. 3A, 3B, and 3C are flowcharts illustrating a software updating method of the wireless terminal 10 according to various embodiments of the present disclosure.

Referring to FIG. 3A, a user or an administrator of the wireless terminal 10, for example, a software update administrator, may access the management server 40 (shown in FIG. 1) to register the update policy of software installed on the wireless terminal 10 (shown in FIG. 1). For example, an administrator or a user may register the update policy of the wireless terminal 10 through a user interface of a web console screen provided by the management server 40. An example of a user interface of a web console screen will be described in more detail later, with reference to FIG. 6.

When an update policy is registered in operation 301, update policy information may be transmitted from the management server 40 to the wireless terminal 10 in operation 303. The process that the update policy information is transmitted from the management server 40 to the wireless terminal 10 may include indirectly transmitting data through a relay such as the portable terminal 50, an AP (not shown), or a base station (not shown) between the management server 40 and the wireless terminal 10 in addition to directly transmitting data from the management server 40 to the wireless terminal 10.

The wireless terminal 10 that receives the update policy information may store the received update policy information in operation 305. Thereafter, the wireless terminal 10 may determine whether a software update is requested in operation 307. For example, when update policy information is transmitted or an update request signal is received from the management server 40, the wireless terminal 10 may determine that a software update is requested. Alternatively, when an update request signal is transmitted from the portable terminal 50, the wireless terminal 10 may determine that an update is requested. Alternatively, when an event for requesting a software update occurs according to a predetermined time or a predetermined period based on a schedule pre-registered in the wireless terminal 10, the wireless terminal 10 may determine that an update is requested.

When it is determined that the update is requested, according to update policy information, the wireless terminal 10 may set an update deadline for updating to the latest software in operation 309. The wireless terminal 10 may determine whether the update deadline is exceeded in operation 311. The update deadline, for example, may be within several days after update request (for example, within 3 days or 7 days) or a specific time slot after update request (for example, 09:00 p.m. to 6:00 a.m.).

When it is determined that the update deadline is exceeded, update failure notification information may be transmitted from the wireless terminal 10 to the management server 40 in operation 313. Additionally or alternatively, update failure notification information may be transmitted to the portable terminal 50 (shown in FIG. 1). Alternatively, the update failure notification information received by the management server 40 may be transmitted from the management server 40 to the portable terminal 50.

When it is determined that the update deadline is not exceeded, the wireless terminal 10 may receive the latest version of software from the software server 30 in operation 315. The latest version of software, for example, may be the entire or part of software update data, or may be a difference value between an old version of software pre-installed on the wireless terminal 10 and the latest version of software. Receiving, by the software server 30, version information on an old version of the software pre-installed on the wireless terminal 10 may be further included. Alternatively, receiving, by the management server 40, the version information on the old version of software and receiving, by the software server 30, the version information from the management server 40 may be further included.

When the latest version of the software is received, the wireless terminal 10 may notify the reception of the latest version of the software to a user or an administrator of the wireless terminal 10. For example, the wireless terminal 10 may transmit software reception notification information to the portable terminal 50. Alternatively, when the wireless terminal 10 transmits software reception notification information to the management server 40, the management server 40 may transmit the software reception notification information to the portable terminal 50. In this case, the portable terminal 50 may provide the received software notification information through an application execution screen or provide it as sound through a speaker. Alternatively, the wireless terminal 10 may provide the software reception notification through an output unit (not shown) of the wireless terminal 10. For example, the software reception notification may be provided through a speaker, a light emitting unit, or a display unit of the wireless terminal 10.

When the latest version of software is received, the wireless terminal 10 may check an installation condition for the latest version of the software according to the update policy information in operation 317. For example, the wireless terminal 10 may determine whether a software installation condition is a time base in operation 319.

When it is determined that the software installation condition is the time base, the wireless terminal 10 may perform a process shown in FIG. 3B. On the other hand, when it is determined that the software installation condition is not the time base in operation 319, the wireless terminal 10 may perform a process shown in FIG. 3C.

When it is determined that the software installation condition is the time base in operation 319 (shown in FIG. 3A), the wireless terminal 10 may set a software installation deadline for installing the latest version of the software in operation 321. The wireless terminal 10 may determine whether the software installation deadline is exceeded by checking the deadline in operation 323. According to an embodiment of the present disclosure, the installation deadline may be shorter than the update deadline. Alternatively, the installation deadline may be a time having the same condition as the update deadline in operation 311 (shown in FIG. 3A). For example, the update deadline may be a specific time slot (for example, 10:00 p.m. to 5:00 a.m.), a specific day, or a specific date after the latest version of the software is received.

When it is determined that the installation deadline is exceeded, the wireless terminal 10 may determine whether the update deadline is exceeded in operation 325. In this case, the update deadline may be longer than the installation deadline. For example, when the update deadline is within 3 days, the installation deadline may be a specific time slot (for example, 10:00 p.m. to 5:00 a.m.) within 3 days. When it is determined that the update deadline is exceeded based on a determination result, update failure notification information may be transmitted from the wireless terminal 10 to the management server 40 in operation 327. The management server 40 that receives the update failure notification information may transmit the update failure notification information to the portable terminal 50 (shown in FIG. 1) to allow a user to know the update failure. Alternatively, the update failure notification information may be directly transmitted from the wireless terminal 10 to the portable terminal 50.

On the other hand, with reference to FIG. 3B, when it is determined that the update deadline is not exceeded, the wireless terminal 10 may continuously determine whether the software installation deadline is exceeded in operation 323.

In operation 323, when it is determined that the installation deadline is not exceeded, the wireless terminal 10 may obtain at least one of state information of the external device 20 and state information of the wireless terminal 10 in operation 329. For example, the wireless terminal 10 may obtain state information of the external device 20 and state information of the wireless terminal 10 at each predetermined period (for example, 10 sec, 20 sec, or 30 sec). Alternatively, when an interrupt signal occurs as the state information of the external device 20 and the state information of the wireless terminal 10 are changed, the wireless terminal 10 may obtain at least one of the state information of the external device 20 and the state information of the wireless terminal 10. Alternatively, when an interrupt signal occurs as the state information of the external device 20 and the state information of the wireless terminal 10 become greater or less than a specific critical value, the wireless terminal 10 may obtain at least one of the state information of the external device 20 and the state information of the wireless terminal 10.

Thereafter, in operation 331, the wireless terminal 10 may determine whether the obtained state information of the external device 20 and the obtained state information of the wireless terminal 10 satisfy an installation condition for the latest version of the software according to the update policy information stored in operation 305.

When it is determined that the installation condition for the latest version of the software is satisfied, update execution notification information may be transmitted from the wireless terminal 10 to the management server 40 in operation 333. Thereafter, the wireless terminal 10 may perform a software update for changing pre-installed software to the latest version of the software in operation 335. The wireless terminal 10 may remove at least part of the pre-installed old version of the software and install the latest version of the software. Alternatively, the wireless terminal 10 may install difference data between the pre-installed old version of the software and the latest version of the software.

In this case, when update execution request information is received from the management server 40 that receives the update execution notification information, the wireless terminal 10 may perform software update.

According to an embodiment of the present disclosure, the update execution notification information may be transmitted from the wireless terminal 10 to the portable terminal 50 (shown in FIG. 1). Alternatively, the update execution notification information may be transmitted from the management server 40 that receives it to the portable terminal 50. When the update execution request information is received from the portable terminal 50, the wireless terminal 10 may perform software update.

Moreover, in operation 319 shown in FIG. 3A, the wireless terminal 10 may determine that the software installation condition is not the time basis.

When it is determined that that the software installation condition is not the time base, referring to FIG. 3C, the wireless terminal 10 may obtain at least one of state information of the external device 20 and state information of the wireless terminal 10 in operation 341. Since the method of the wireless terminal 10 to obtain state information of the external device 20 (shown in FIG. 1) and state information of the wireless terminal 10 is described in operation 329 (shown in FIG. 3B), its detailed description may be omitted.

When at least one of state information of the external device 20 and state information of the wireless terminal 10 is obtained, in operation 343, the wireless terminal 10 may determine whether at least one of the obtained state information of the external device 20 and the obtained state information of the wireless terminal 10 satisfies an installation condition for the latest version of software according to the update policy information stored in operation 305.

When it is determined that the installation condition for the latest version of software is satisfied, update execution notification information may be transmitted from the wireless terminal 10 to the management server 40 in operation 345. Then, the wireless terminal 10 may perform a software update for changing pre-installed software to the latest version of software in operation 347. Since the performing of the software update by the wireless terminal 10 is described in operation 331 to operation 335 (shown in FIG. 3B), its detailed description may be omitted.

On the other hand, with reference to FIG. 3C, when it is determined that the installation condition for the latest version of software is not satisfied, the wireless terminal 10 may determine whether the update deadline is exceeded in operation 349. When it is determined that the update deadline is exceeded based on a determination result, update failure notification information may be transmitted from the wireless terminal 10 to the management server 40 in operation 351. The management server 40 that receives the update failure notification information may transmit the update failure notification information to the portable terminal 50 (shown in FIG. 1) to allow a user to know the update failure. Alternatively, the update failure notification information may be directly transmitted from the wireless terminal 10 to the portable terminal 50. In this case, in order to allow a user or an administrator to know an update failure reason, the state information of the external device 20 (shown in FIG. 1) obtained by the wireless terminal 10 may be transmitted to the management server 40 or the portable terminal 50.

When it is determined that the update deadline is not exceeded, the wireless terminal 10 may continuously obtain at least one of state information of the external device 20 and state information of the wireless terminal 10 in operation 341, and monitor the state information of the external device 20 and the state information of the wireless terminal 10.

FIGS. 4 and 5 are syntax for representing an example of update policy information according to various embodiments of the present disclosure.

FIG. 4 is a view illustrating a syntax for repeatedly attempting an update at a predetermined period, and FIG. 5 is a view illustrating a syntax for attempting an update when a condition is satisfied.

When a user or an administrator of the wireless terminal 10 accesses the management server 40 to register the update policy, the update policy information shown in FIGS. 4 and 5 may be obtained from the management server 40 and stored in the storage unit 12 of the wireless terminal 10.

Referring to FIG. 4, a syntax 401 represents that an update policy is a policy for repeatedly attempting an update at a predetermined period.

A syntax 402 may represent an update request time. For example, in the syntax 402, an update request time may be 13:30 Jun. 1, 2015.

A syntax 403 represents a condition for not performing an update. The condition for not performing an update in the syntax 403, for example, may be a condition that a vehicle, that is, the external device 20 (shown in FIG. 1), is in a driving state or a moving state. In this case, the condition that a vehicle is in a driving state may be determined based on the state information of the external device 20. For example, the wireless terminal 10 may determine that a vehicle, that is, the external device 20, is in a driving state based on the state information of the external device 20 received from the external device 20. In this case, since the type of state information of the external device 20 received by the wireless terminal 10 is apparent to those skilled in the art, its detailed description is omitted. Alternatively, the wireless terminal 10 may determine the state information of the external device 20 based on the information collected by the detection unit 13, and based on this, determine that a vehicle of the external device 20 is in a driving state or a moving state.

A syntax 404 may represent a repetition condition for attempting an update when the update is not performed. In the syntax 404, the number of update repetition attempts may be 3, and an update repetition attempt may be performed at 10 min, 20 min, and 30 min elapse time points at a 10 min interval.

Referring to FIG. 5, a syntax 501 represents that an update is attempted when an update policy satisfies a condition.

A syntax 502 may represent an update request time. For example, in the syntax 502, an update request time may be 13:30 Jun. 1, 2015.

A syntax 503 represents a condition for not performing an update. The condition for not performing an update in the syntax 503, for example, may be a condition that a vehicle, that is, the external device 20, is in a driving state or a moving state. The condition that a vehicle is in a driving state may be determined based on the state information of the external device 20. For example, the wireless terminal 10 may determine that a vehicle, that is, the external device 20, is in a driving state based on the state information of the external device 20 received from the external device 20. Alternatively, the wireless terminal 10 may determine the state information of the external device 20 based on the information collected by the detection unit 13, and based on this, determine that the external device 20, that is, a vehicle, is in a driving or moving state.

A syntax 504 may represent an update deadline. In the syntax 504, the update deadline may be within 1 hr after an update request. For example, while monitoring state information of the external device 200 within 1 hr after an update request, if an update condition is satisfied, the wireless terminal 10 may perform update. If the update is not performed within 1 hr after the update request, the wireless terminal 10 may perform update failure notification information to the management server 40 or the portable terminal 50.

FIG. 6 is a view illustrating a screen for registering an update policy according to an embodiment of the present disclosure.

FIG. 6 may be a console screen provided through a terminal of the management server 40 in order to allow an administrator to register an update policy.

According to an embodiment of the present disclosure, FIG. 6 may provide an application execution screen provided through the portable terminal 50 in order to allow a user of the portable terminal 50 to register an update policy. In this case, when a user registers an update policy through the application execution screen, update policy information relating to the registered update policy may be transmitted to the wireless terminal 10 through the management server 40. Alternatively, the update policy information may be directly transmitted from the portable terminal 50 to the wireless terminal 10 without passing through the management server 40. Between the portable terminal 50 and the wireless terminal 10, update policy information may be transmitted/received using a Wi-Fi method, a BT method, or an NFC method.

An administrator or a user may register an update policy through a user interface of FIG. 6.

The update policy registration screen of FIG. 6 may include a user interface 610 for setting an update policy and a user interface 620 for setting an update block state.

The user interface 610 for setting an update policy may include an update policy setting item 611, an update policy selection item 612, an update attempt period selection item 613, a time type selection item 614, an update start time and end time selection item 615, an update block state list item 616 for representing an operating state of an external device that does not perform update, and an update block state addition item 617.

Additionally, the user interface 620 or setting a condition of an update block state may include a temperature selection item 621 of the external device 20 (shown in FIG. 1), an impact selection item 622 of the external device 20, and a battery level selection item 623 of the external device 20.

In addition, although not shown in the drawing, the update policy registration screen may further include a menu for registering an operating state (for example, during driving, during stopping, or during starting) of the external device 20 in order to set an update block state or an update permission state. Alternatively, the update policy registration screen may further include a menu for registering an operating state (for example, insufficiency in a battery remaining amount, a temperature of more than a predetermined value, and so on) of the wireless terminal 10 in order to set an update block state or an update permission state.

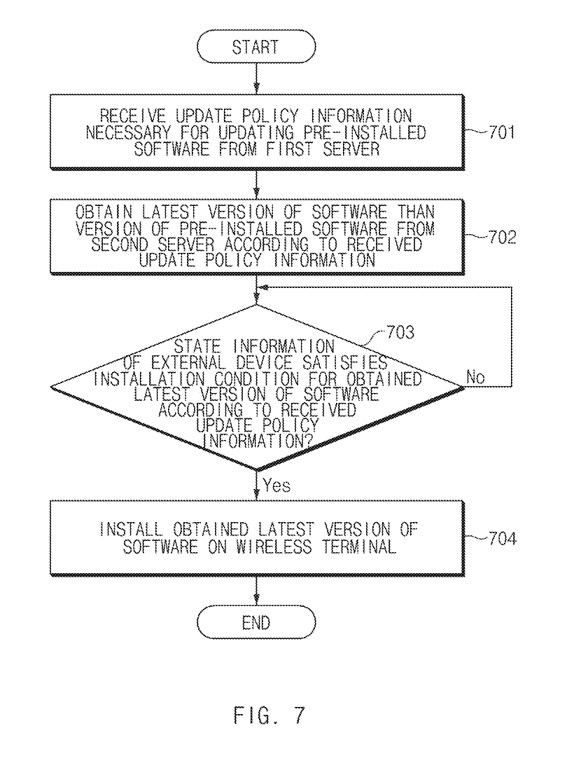

FIG. 7 is a flowchart for updating software of the wireless terminal 10 according to an embodiment of the present disclosure.

Referring to FIG. 7, in operation 701, the wireless terminal 10 may receive update policy information necessary for updating software pre-installed on the wireless terminal 10, from a first server (for example, the management server 40). The update policy information may be information relating to an update policy registered by a user or an administrator accessible to the first server. Additionally, the update policy information may include at least one of an update available time of the latest version of software, state information of an update available or an unavailable external device, an update period.

In operation 702, according to the received update policy information, the wireless terminal 10 may obtain the latest version of the software in comparison to the software pre-installed on the wireless terminal 10, from a second server (for example, the software server 30). At this point, the first server and the second server may be the same server.

In operation 703, according to the received update policy information, the wireless terminal 10 may determine whether state information of the external device 20 (shown in FIG. 1) satisfies an installation condition for the obtained latest version of the software. The state information of the external device 20, for example, may include at least one of a battery remaining amount of the external device 20, a temperature of the external device 20, a moving speed of the external device 20, and an acceleration of the external device 20.

If the state information of the external device 20 satisfies the installation condition for the obtained latest version of software, in operation 704, the wireless terminal 10 may install the obtained latest version of the software thereon. The wireless terminal 10 may transmit update execution notification information for notifying a software installation schedule to at least one of the first server, the second server, and the portable terminal 50. If update execution request information according to an update execution instruction of a user or an administrator of the wireless terminal 10 is received, the wireless terminal 10 may install the obtained latest version of the software thereon.

If the state information of the external device 20 (shown in FIG. 1) does not satisfy the installation condition for the obtained latest version of software, while continuously monitoring the state information of the external device 20, the wireless terminal 10 may determine whether the state information of the external device 20 satisfies the installation condition for the latest version of software.

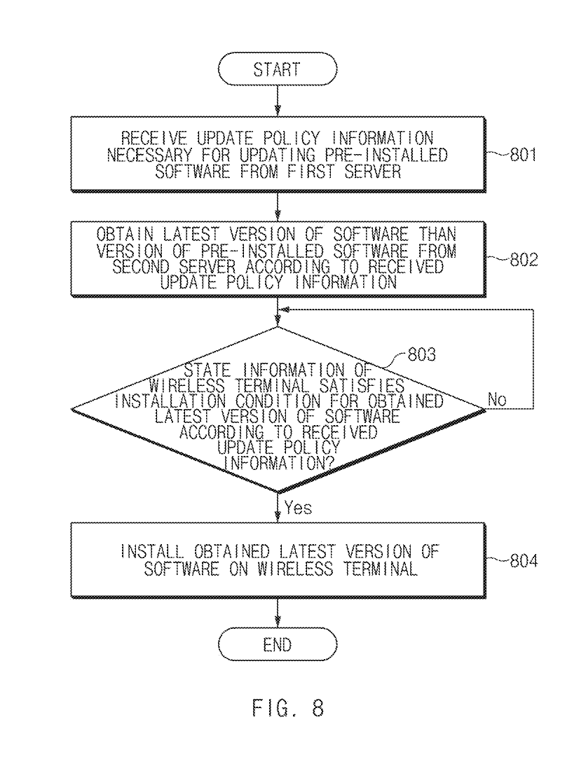

FIG. 8 is a flowchart for updating software of the wireless terminal 10 according to an embodiment of the present disclosure.

Referring to FIG. 8, in operation 801, the wireless terminal 10 may receive update policy information necessary for updating software pre-installed on the wireless terminal 10, from a first server (for example, the management server 40).

In operation 802, according to the received update policy information, the wireless terminal 10 may obtain the latest version of the software in comparison to the software pre-installed on the wireless terminal 10, from a second server (for example, the software server 30).

In operation 803, according to the received update policy information, the wireless terminal 10 may determine whether state information of the external device 10 satisfies an installation condition for the obtained latest version of the software. At this point, the state information of the wireless terminal 20, for example, may include at least one of an amount of battery charge remaining in the wireless terminal 10, a location of the wireless terminal 10, a temperature of the wireless terminal 10, and a communication state of the wireless terminal 10.

If the state information of the wireless terminal 10 satisfies the installation condition for the obtained latest version of software, in operation 804, the wireless terminal 10 may install the obtained latest version of software thereon. In this case, the wireless terminal 10 may transmit update execution notification information for notifying a software installation schedule to at least one of the first server, the second server, and the portable terminal 50 (shown in FIG. 1). Accordingly, if update execution request information according to an update execution instruction of a user or an administrator of the wireless terminal 10 is received, the wireless terminal 10 may install the obtained latest version of software thereon.

On the other hand, if the state information of the wireless terminal 10 does not satisfy the installation condition for the obtained latest version of software, while continuously monitoring the state information of the wireless terminal 10, the wireless terminal 10 may determine whether the state information of the wireless terminal 10 satisfies the installation condition for the latest version of software.

According to various embodiments of the present disclosure, in consideration of various situations of an external device that communicates with a wireless terminal, software of the wireless terminal may be updated.

For example, according to a software update policy set by an administrator or a user of a wireless terminal, the software of the wireless terminal may be updated safely in various situations of an external device. Accordingly, a situation that a function of a wireless terminal is limited by the software update of the wireless terminal may be minimized.

At least a part of devices (e.g., modules or the wireless terminal device 10) or methods (e.g., operations) according to various embodiments of the present disclosure may be implemented as instructions stored in a computer-readable storage medium in the form of a program module. In the case where the instructions are performed by a processor (e.g., the control unit 14), the processor may perform functions corresponding to the instructions. The computer-readable storage medium may be, for example, the storage unit 12.

A computer-readable recording medium may include a hard disk, a floppy disk, a magnetic medium (e.g., a magnetic tape), an optical medium (e.g., CD-ROM, DVD), a magneto-optical medium (e.g., a floptical disk), or a hardware device (e.g., a read only memory (ROM), a random access memory (RAM), a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for updating software installed on a wireless terminal communicable with an external device, a first server, and a second server, the method comprising:
receiving, at the wireless terminal, update policy information on the software from the first server;
obtaining, at the wireless terminal, a latest version of the software from the second server; and
if state information of the external device satisfies an installation condition for the obtained latest version of the software according to the received update policy information, installing the obtained latest version of the software on the wireless terminal.

2. The method of claim 1, the installing of the obtained latest version of the software on the wireless terminal comprises:
receiving an update execution request from the first server; and
installing the obtained latest version of the software on the wireless terminal in response to the update execution request.

3. The method of claim 1, further comprising:
transmitting notification information on an update state of the software to at least one of the first server, the second server, and a portable terminal of a user of the wireless terminal.

4. The method of claim 1, wherein the latest version of the software comprises a whole or a part of the software update data or difference data between an old version of pre-installed software and the latest version of the software.

5. The method of claim 1, further comprising:
obtaining the state information of the wireless terminal,
wherein the installing of the latest version of the software on the wireless terminal comprises:
if the obtained state information of the wireless terminal satisfies an installation condition of the obtained latest version of the software according to the update policy information, installing the obtained latest version of the software on the wireless terminal.

6. The method of claim 5, wherein the state information of the wireless terminal comprises:
at least one of an amount of battery charge remaining in the wireless terminal, a location of the wireless terminal, a temperature of the wireless terminal, and a communication state of the wireless terminal.

7. The method of claim 1, wherein the obtaining of the latest version of the software according to the received update policy information on the software comprises:
obtaining the latest version of the software from the second server.

8. The method of claim 1, further comprising:
determining whether the state information of the external device satisfies an installation condition of the obtained latest version of the software according to the received update policy information.

9. A wireless terminal communicable with an external device, a first server, and a second server, the wireless terminal comprising:
a communication circuit configured for:
receiving update policy information on an update of the software installed on the wireless terminal from the first server, and
obtaining a latest version of the software newer than a version of the software from the second server; and
a processor configured to control for:
if state information of the external device satisfies an installation condition of the obtained latest version of the software according to the received update policy information, installing the obtained latest version of the software on the wireless terminal.

10. The wireless terminal of claim 9, wherein the update policy information comprises information relating to an update policy registered by a user of the wireless terminal or an administrator who accesses the first server.

11. The wireless terminal of claim 9, wherein the update policy information comprises at least one of an update available time of the latest version of the software, state information of an available update or information about an unavailable external device of the latest version of the software, and an update attempt period of the latest version of the software.

12. The wireless terminal of claim 9, wherein the state information of the external device comprises at least one of an amount battery charge remaining in the external device, a temperature of the external device, a moving speed of the external device, information on an operating state of the external device, a sensor value of a gyroscope of the external device, and an acceleration of the external device.

13. The wireless terminal of claim 9, wherein, when the communication circuit receives update execution request information, the processor is further configured to control for installing the obtained latest version of the software on the wireless terminal.

14. The wireless terminal of claim 9, wherein the communication circuit transmits notification information on an update state of the software to at least one of the first server, the second server, and a portable terminal of a user of the wireless terminal.

15. The wireless terminal of claim 9,
wherein the wireless terminal further comprises a detection unit configured for obtaining the state information of the external device, and
wherein when the state information of the external device obtained by the detection unit satisfies an installation condition of the obtained latest version of the software according to the update policy information, the processor is further configured to control for installing the obtained latest version of the software on the wireless terminal.

16. The wireless terminal of claim 9,
wherein the communication circuit obtains state information of the external device from the external device, and
wherein, when the state information of the external device obtained by the communication circuit satisfies an installation condition of the obtained latest version of the software according to the update policy information, the processor is further configured to control for installing the obtained latest version of the software on the wireless terminal.

17. The wireless terminal of claim 9,
wherein the communication circuit comprises a first communication circuit configured for:
receiving update policy information necessary for updating the software from the first server, and
obtaining the latest version of the software from the second server in a wireless communication method, and
wherein the wireless terminal further comprises:
a second communication circuit configured to obtain the state information of the external device from the external device in a wired communication method.

18. The wireless terminal of claim 9, wherein the communication circuit obtains the latest version of the software newer than a version of the software from the second server according to the received update policy information on the software.

19. The wireless terminal of claim 9, wherein, if the state information of the external device satisfies an installation condition of the obtained latest version of the software according to the received update policy information, the processor is further configured to control for:
installing the obtained latest version of the software on the wireless terminal.

20. A wireless terminal communicable with an external device, a portable terminal, and a server, the wireless terminal comprising:
a communication circuit configured for:
receiving update policy information necessary for updating software installed on the wireless terminal from the portable terminal, and
obtaining the latest version of the software newer than a version of the software from the server; and
a processor configured to control for:
if state information of the external device satisfies an installation condition of the obtained latest version of the software according to the received update policy information, installing the obtained latest version of the software on the wireless terminal.
